(19) United States
(12) Patent Application Publication
(10) Pub. No.: US 2024/0001785 A1
(43) Pub. Date: Jan. 4, 2024

(54) EV CHARGERS AND EV CHARGING

(71) Applicant: Khalifa University of Science and Technology, Abu Dhabi (AE)

(72) Inventors: Vinod Madhavrao KHADKIKAR, Abu Dhabi (AE); Radha KUSHWAHA, Abu Dhabi (AE); Hatem ZEINELDIN, Abu Dhabi (AE); Hadi OTROK, Abu Dhabi (AE); Rabeb MIZOUNI, Abu Dhabi (AE); Shakti SINGH, Abu Dhabi (AE); Umesh Shantaveerappa BAKTHARAHALLI, Abu Dhabi (AE); Amarendra EDPUGANTI, Abu Dhabi (AE); Abass Afolabi YAHAYA, Abu Dhabi (AE)

(21) Appl. No.: 18/038,557

(22) PCT Filed: Nov. 23, 2021
(86) PCT No.: PCT/IB2021/060888

§ 371 Date: May 24, 2023

Related U.S. Application Data
(60) Provisional application No. 63/117,621, filed on Nov. 24, 2020.

(51) Int. Cl. B60L 53/22; H02J 7/02; B60L 53/16

(52) U.S. Cl. CPC B60L 53/22; H02J 7/02; B60L 53/16; H02J 2207/40; H02J 2310/48; H02J 2207/20; B60L 2210/12; B60L 2210/14

(57) ABSTRACT

A charger includes a buck converter; and a converter connected to the buck converter. The converter is either a totem pole BL boost structure at the input side, a switched inductor Cuk converter at the output side, or a BL Zeta converter. The charger may be a type-I on-board EV charger or a type-II on-board EV charger.

### BACKGROUND

The present invention relates generally to charging batteries and in particular to recharging electric vehicle (EV) batteries.

Amid the environmental concerns and emphasis on low greenhouse gas emissions, electric transportation has seen constant acceleration as the sale of EVs is rising at double the rate from the previous year. EVs need battery storage energy as their continuous support of propelling power.

The United States Department of Energy has classified EV chargers based on three voltage/power levels, as follows: level-1 chargers have power less than 5 kW, level-2 chargers are fast-chargers with a power level between 5 kW and 50 kW, and level-3 chargers are super-fast DC charging with a power level greater than 50 kW. Level-3 chargers are further termed as off-board chargers, which provide DC power to the vehicle and, due to heavy weight, the charging circuit is installed outside the vehicle.

### SUMMARY

According to one aspect, a charger includes a buck converter; and a converter that includes a totem pole BL boost structure at the input side, a switched inductor Cuk converter at the output side, the output side connected to the buck converter.

According to another aspect, a charger includes a buck converter; and a bridgeless Zeta power factor control (BL Zeta PFC) converter. The BL Zeta PFC converter includes an EMI filter connected to a BL Zeta power factor correction (PFC) converter, which is connected to the buck converter.

According to another aspect, an electric vehicle configured for simultaneous AC and DC charging includes an on-board charger; a battery; and a charging port in electrical communication with the on-board charger and the battery. The charging port includes a first portion configured to be in electrical communication with an AC source and a second portion configured to be in electrical communication with a DC source.

According to another aspect, a system for simultaneous AC and DC charging of an electrical vehicle includes an AC source; a DC source in electrical communication with a DC-DC converter, wherein the DC-DC converter is configured for electrical communication with a DC source; and an AC and DC inlet connector, wherein the AC and DC inlet connector comprises a first portion in electrical communication with the AC source and a second portion in electrical communication with an off-board DC-DC converter in electrical communication with the DC source.

According to another aspect, an EV vehicle configured for simultaneous AC and DC charging includes a motor, a DC link, and a DC input port, wherein the DC input port has a positive terminal in electrical communication with the motor and a negative terminal in electrical communication with a negative terminal of the DC link.

According to another aspect, an EV vehicle configured for simultaneous AC and DC charging includes a battery; a first port configured to charge the battery using energy from an off-board AC source and an off-board DC source; and a second port configured to charge the battery using energy from an off-board DC source.

According to another aspect, an EV vehicle configured for simultaneous AC and DC charging includes an on-board charger; a battery; a drivetrain with motor windings and inverter; a DC link; and a DC input port in electrical communication with a neutral point of a motor winding of the motor and a negative terminal of the DC link.

According to another aspect, an EV vehicle includes an on-board charger; an on-board DC-DC converter; a battery in electrical communication with the on-board DC-DC converter; a charging port in electrical communication with the battery and the on-board charger; a DC Link with a positive terminal and a negative terminal; a drivetrain voltage source inverter; an EV motor; and a DC input port with a positive terminal in electrical communication with the EV motor and a negative terminal in electrical communication with the negative terminal of the DC link.

### DESCRIPTION OF THE DRAWINGS

FIG. 1 is a circuit diagram illustrating the topology of a bridgeless switched inductor Cuk PFC converter—Buck converter (BLSI Cuk Buck charger), according to some embodiments.

FIGS. 2A-C are circuit diagrams illustrating different stages of operation for a BLSI Cuk Buck charger, according to some embodiments.

FIG. 3 are waveform diagrams illustrating the different stages of operation shown in FIGS. 2A-C, according to some embodiments.

FIG. 4 illustrates a controller for a BLSI Cuk Buck charger, according to some embodiments.

FIG. 5 illustrates a controller for a BLSI Cuk Buck charger, according to some embodiments.

FIGS. 6A-F are graphs illustrating the results of simulation studies. FIGS. 6A-B is a graph illustrating the results of a simulation study for a BLSI Cuk Buck charger based on a maximum switch utilization approach at 1 kW. FIG. 6B is a zoomed-in view of FIG. 6A. FIGS. 6C-D is a graph illustrating the results at 2 kW. FIG. 6D is a zoomed-in view of FIG. 6C.

FIG. 7 is a graph comparing battery state of charge (SOC) rates for a BLSI Cuk Buck charger to a rate of a typical EV charger.

FIG. 8 is a circuit diagram illustrating the topology of a BL Zeta Buck charger, according to some embodiments.

FIGS. 9A-B are circuit diagrams illustrating the topology of control circuits for a BL Zeta Buck charger, according to some embodiments.

FIGS. 10A-C are circuit diagrams illustrating different stages of operation for a BL Zeta Buck charger, according to some embodiments.

FIG. 11 are waveform diagrams illustrating the different stages of operation shown in FIGS. 10A-C, according to some embodiments.

FIG. 12 is a graph illustrating the results of a steady state simulation study for a BL Zeta Buck charger.

FIGS. 13A-D are graphs illustrating the results of transient performance of a BL Zeta Buck charger.

FIGS. 14A-B are graphs illustrating the results of transient performance of a BL Zeta Buck charger during startup (FIG. 14A) and shutdown (FIG. 14B).

FIG. 15 is a graph comparing battery SOC rates for a BL Zeta Buck charger to a rate of a typical slow EV charger.

FIG. 16 is a schematic illustrating a simultaneous AC and DC charging system, according to some embodiments.

FIG. 17 is a schematic illustrating a simultaneous AC and DC charging system, according to some embodiments.

FIG. 18 is a table providing AC and DC inlet pin descriptions for a CCS2 combo EV charging port, according to some embodiments.

FIG. 19 is a circuit diagram illustrating a control system for simultaneous AC and DC charging system, according to some embodiments.

FIG. 20 is a graph of simulation results for a simultaneous AC and DC charging system, according to some embodiments.

FIG. 21 is a graph showing EV battery voltage V_{bt}, current i_{bt}, and state of charge (SoC) for a simulation of a simultaneous AC and DC charging system, according to some embodiments.

FIG. 22 is a graph showing single-phase grid voltage Vₐ and current Iₐ at unit power factor operation for simulation results for a simultaneous AC and DC charging system, according to some embodiments.

FIG. 23 is a schematic illustration of a simultaneous AC and DC charging system, according to some embodiments.

FIG. 24 is a circuit diagram of a control system for the simultaneous AC and DC charging system of FIG. 23, according to some embodiments.

FIG. 25 is a graph showing input phase currents and phase voltages of a type-2 charger operating at unity power factor (V_{ga}, V_{gb}, V_{gc} and I_{ga}, I_{gb}, I_{ge}), according to some embodiments.

FIG. 26 is a graph showing high-frequency DC currents of three legs of IBC for a 2 C rate charging of EV battery according to a simulation of the simultaneous AC and DC charging system of FIG. 23, according to some embodiments.

FIG. 27 is a graph showing average power transferred through Type-2 on board charger Pₒ₁, IBC Pₒ₂ and the battery side DC-DC converter P_{bat}, and the DC-link voltage V_{dc} during a simulation of the simultaneous AC and DC charging system of FIG. 23.

FIG. 28 is a graph showing battery SoC, current I_{bt}, and terminal voltage V_{b} during a simulation of the simultaneous AC and DC charging system of FIG. 23.

FIG. 29 is a graph showing battery SoC rise with an increase in the power rating of the additional DC source with 19 kW base AC charging during a simulation of the simultaneous AC and DC charging system of FIG. 23.

### DETAILED DESCRIPTION

In one aspect, the present disclosure is directed generally to converters, chargers, EV chargers, and/or EV vehicles. In one embodiment disclosed herein, the charger is a bridgeless switched inductor Cuk PFC converter—Buck converter charger (BLSI Cuk Buck charger). This embodiment includes a BLSI Cuk PFC converter and a Buck converter. In a second embodiment disclosed herein, the charger disclosed is a bridgeless Zeta Buck charger. This embodiment includes a BL Zeta PFC converter as disclosed herein. The chargers disclosed herein may be configured as a fast (type-II) on-board EV charger, as a slow (type-I) on-board EV charger, or as an off-board charger (e.g., a type-III charger or another type of charger).

In another aspect, the present disclosure is directed generally to EV vehicles, charging ports, and/or systems for simultaneous AC and DC charging. In one embodiment, a charging port for simultaneous AC and DC charging is a CCS2 combo EV charging port. In another embodiment, a charging port for simultaneous AC and DC charging includes a Type-2 port and a CHAdeMo port. In one embodiment, a system for simultaneous AC and DC charging includes an off-board DC-DC converter. In another embodiment, an EV vehicle configured for simultaneous AC and DC charging includes a DC input port in electrical communication with the EV drivetrain and a port for charging an on-board charger. As discussed in greater detail below, the EV chargers and/or EV charging systems disclosed herein provide for reduced battery charging time.

I. EV Chargers

I.A. BLSI Cuk Buck Charger

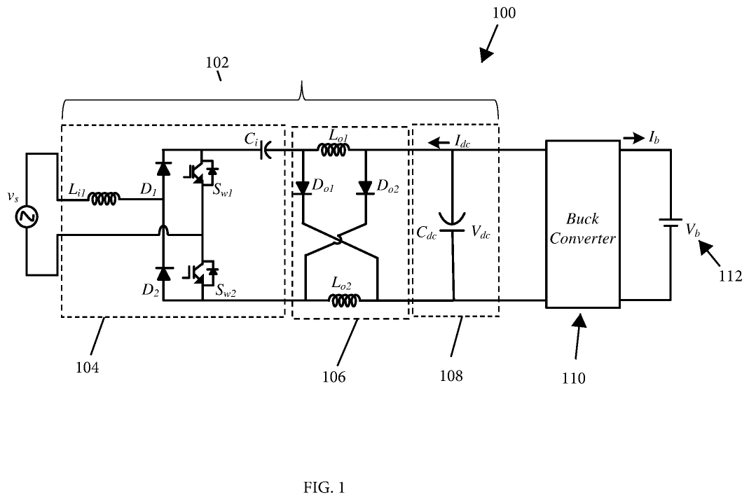

FIG. 1 is a circuit diagram illustrating the topology of a BLSI Cuk Buck EV charger 100. In some embodiments, the BLSI Cuk Buck EV charger is an on-board charger for an electric vehicle. The BLSI Cuk Buck EV charger includes a BLSI Cuk PFC converter 102, a buck converter 110. The buck converter 110 is configured to be connected to the positive and negative terminals of the battery V_{b} 112.

The BL Cuk PFC converter 102 includes a totem pole BL boost structure 104 at the input side, a switched inductor Cuk converter 106 at the output side, and a DC-Link 108. The DC link 108 includes a DC link capacitor C_{dc} and a DC link voltage V_{cd}. The DC link 108 is electrically connected to the buck converter 110. The switched inductor Cuk converter 106 has output inductors L_{o1,2} and output diodes D_{o1,2} that are split into two parts to work in switched inductor configuration.

The totem pole BL boost structure 104 is connected to an AC source vₛ. The totem pole BL boost structure 104 includes an input inductor Lᵢ, two line diodes D₁ and D₂, two switches S_{w1} and S_{w2}, and an intermediate capacitor Cᵢ. The switches S_{w1} and S_{w2} both operate simultaneously during both the positive and negative half cycles, however, diodes D₁ and D₂ operate alternately in positive and negative half-cycles. The intermediate capacitor Cᵢ works to transfer the energy from input to output of the totem pole BL boost structure 104.

The totem pole BL boost structure 104 has a first node where the AC input vₛ is connected to the input inductor Lᵢ, a second node where the cathode of D₁, switch S_{w1}, and the positive side of intermediate capacitor Cᵢ are connected, a third node where switches S_{w1,2} and the AC input vₛ are connected, a fourth node where the input inductor Lᵢ, the anode of diode D₁ and the cathode of diode D₂ are connected, and a fifth node where anode of diode D₂, and switch Sw2 are connected. The switched inductor Cuk converter 106 is connected to the fifth node of the totem pole BL boost structure 104 and to the negative side of the intermediate capacitor Cᵢ of the totem pole BL boost structure 104.

The switched inductor Cuk converter 106 has a first node where the output inductor Lₒ₁, the anode of output diode Dₒ₁ are connected to one another and to the negative side of the intermediate capacitor Cᵢ of the totem pole BL boost structure 104, a second node where the output inductor Lₒ₁ and the anode of diode Dₒ₂ are connected, a third node where the cathode of diode Dₒ₁ and output inductor Lₒ₂ are connected, and a fourth node where the cathode of diode Dₒ₂ and output inductor Lₒ₂ are connected to one another and to the fifth node of the totem pole BL boost structure 104. The second node of the switched inductor Cuk converter 106 is also connected to the negative side of the DC-link 108 and to the buck converter 110. The third node of the switched inductor Cuk converter 106 is also connected to the positive side of the DC-link 108 and to the buck converter 110.

The BLSI Cuk Buck charger has a switch current and a switch voltage respectively represented by:

$${I}_{i n} + \frac{{I}_{d c}}{2} = \frac{{dI}_{d c}}{2} ( 1 - d ) + \frac{{I}_{d c}}{2} \qquad ( 1 )$$

$${V}_{l n} + 2 {V}_{d c} \qquad ( 2 )$$

This configuration produces BLSI Cuk PFC charger with a high step-down gain, which incurs less switch voltage and current stress. Lower switch stress with the BLSI Cuk PFC charger provides for the utilization of switch margins to the maximum range by pushing a higher DC-link voltage. The charging time for the battery is reduced significantly than for conventional slow chargers. Discontinuous conduction mode (DCM) operation of the BLSI Cuk PFC charger ensures a lower volume of magnetic components at this power range. A benefit of the bridgeless structure is that it provides reduced conduction loss. This ensures better thermal utilization of switches and diodes used in the BLSI Cuk PFC charger. Even without using an EMI filter (a filter capacitor), an improved power factor (PF) based charging is facilitated for the battery in two modes (i.e. constant current (CC) and constant voltage (CV) charging), and low current distortion is achieved at the mains. The control has less complexity due to the use of fewer sensors in the DCM operated BLSI Cuk PFC charger, as compared to typical buck-boost converter chargers, which require continuous conduction mode (CCM) operation and hence, more sensors, to operate in a high power range.

The configuration of the BLSI Cuk PFC converter provides half the step-down gain at the PFC stage i.e. M=d/2(1−d) as compared to typical buck-boost converters, i.e. M=d/(1−d), where d is the duty cycle of PFC converter and M is the voltage gain expressed as V_{dc}/Vᵢₙ. The DC-link voltage V_{dc} is represented by:

$${V}_{d c} = \frac{d}{2 ( 1 - d )} {V}_{i n} \qquad ( 3 )$$

To produce the same DC-link voltage V_{dc} the BLSI Cuk PFC converter operates at a higher duty cycle. This provides a larger value of DCM or output inductor than the typical buck boost converter. Therefore, other than the rated voltage stress of Vᵢₙ+2V_{dc} for the BLSI Cuk Buck charger, the switch incurs no additional voltage stress due to resonance, unlike the typical case. Therefore, with this topology, the BLSI Cuk PFC converter switches show a sufficient operating margin to utilize the switches to full capacity. To increase the switch voltage the BLSI Cuk PFC converter is operated at a higher DC-link voltage since input voltage and battery voltage is fixed. It is to be noted that this push in DC-link voltage allows the extension in power, which facilitates a higher charging current for the battery using a buck converter for the next stage.

In some embodiments, the switch stresses may be increased to 800V, 60A to provide fast charging within safe operating margins for a 1200V, 100A switch. The DC-link voltage of the BLSI Cuk PFC converter is controlled at 200V, instead of 65V for a typical single-stage case, or instead of 100V for the two-stage case, which results in an increase in charger power rating from 1 kW to 2 kW. This high DC-link voltage is further stepped down to the battery voltage using a typical buck converter for the next stage. The typical chargers use a battery current of 0.1 C A(C=capacity in Ah) in CC mode, which takes around 8-9 hours to fully charge a 100 Ah battery. If the output voltage of the buck converter of a BLSI Cuk Buck charger is controlled at 65V, a 48V battery can be charged four times faster than the typical buck-boost single-stage charger. Both the Cuk and Buck converters are designed to operate in DCM which provides the advantages of inherent PFC at the mains, reduced recovery losses in diodes, and reduced sensors in the circuit.

Operation of the BLSI Cuk Converter

Due to symmetric operation in positive and negative half-line, only positive half cycle operation was considered for an analysis of the BLSI Cuk PFC converter. Steady-state operation of the BLSI Cuk PFC converter for one switching cycle was analyzed with the following assumptions: a) all components are ideal, b) within one switching cycle, input and output voltages are constant, and c) the output capacitor is bulky enough to maintain output voltage constant Moreover, the inductors, Lₒ₁, and Lₒ₂ are assumed to have equal inductance, Lₒ. Therefore,

Lₒ₁=Lₒ₂=V_{L0}V_{Lo1}=V_{Lo2}=V_{L0}I_{Lo1}=I_{Lo2}=I_{L0} (4)

Operating Stages/Modes of BLSI Cuk PFC Converter

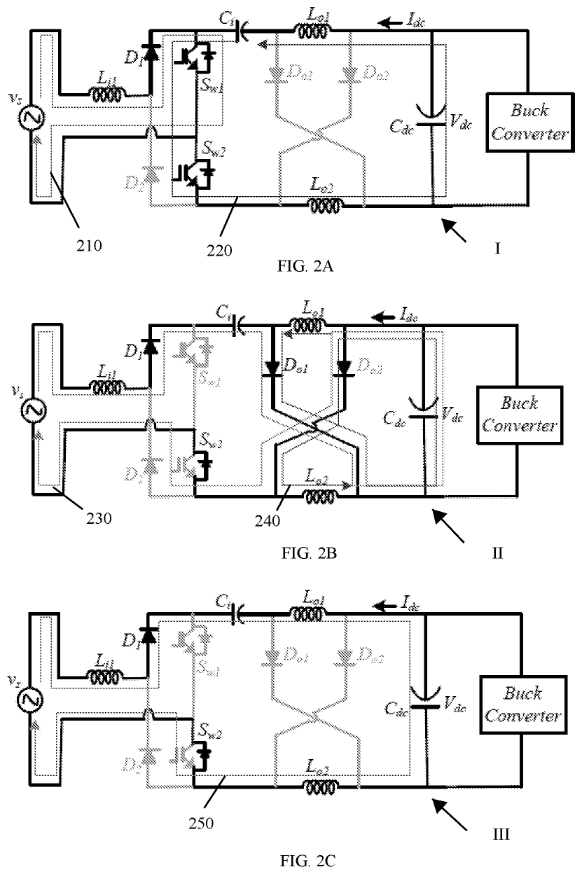

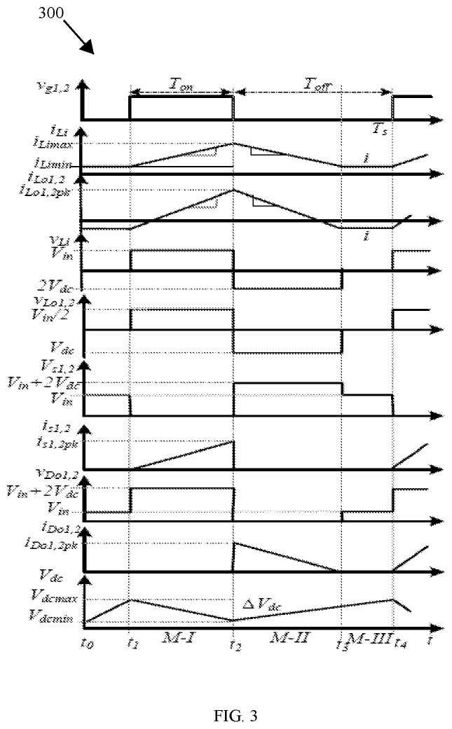

Based on switch on, switch off, and DCM regions, the BLSI Cuk PFC converter has three operating stages/modes. The different operating modes and their flow paths are shown in FIGS. 2A-C. FIG. 3 is a graph 300 of the key waveforms for times to t₀ after t₄ which includes the different modes.

FIG. 2A shows the flow paths 210, 220 of the first stage/mode (M-I). Stage-I starts at t₁ or tₒₙ when switches S_{w1} and S_{w2} are turned ON simultaneously. The line diode D is in conducting state. The input inductor Lᵢ starts storing the energy from the supply voltage. The voltage across the capacitor Ci decreases through the switches S_{w1}, S_{w2}, and inductors Lₒ₁, Lₒ₂, as shown in FIG. 2A. The diodes Dₒ₁ and Dₒ₂ remain in reverse bias. Key waveforms during this mode are shown in FIG. 3 for which the voltage and current expression are given as follows:

$${V}_{L i} = {L}_{i} \frac{{di}_{Li}}{dt} = {V}_{in} ( t ) {V}_{Lo 1} = {V}_{L o 2} = \frac{{V}_{i n} ( t )}{2} \qquad ( 5 )$$

$${i}_{s 1} = {i}_{s 2} = {i}_{L i} + {i}_{L o} {i}_{D o 1} = {i}_{D o 2} = 0 \qquad ( 6 )$$

where V_{Li} and i_{Li} are the voltage and current in the input inductor respectively and V_{Lo1,2} and k_{Lo1,2} are the voltage and current in the output inductors L_{o1,2}. The expressions for the input and output inductor currents (i_{Li} and i_{Lo1,2}) are given as:

$${i}_{L i} ( t ) = \frac{{V}_{i n}}{{L}_{i}} {t}_{o n} + {I}_{{L}_{i min}} \qquad ( 7 )$$

$${i}_{Lo 1 , 2} ( t ) = \frac{{V}_{i n}}{2 {L}_{o 1 , 2}} {t}_{o n} + {I}_{Lo 1 , 2 𝔪in} \qquad ( 8 )$$

FIG. 2B shows the flow paths 230, 240 of the second stage/mode (M-II). Stage-II starts at t₂ when both the switches S_{w1} and S_{w2} are turned OFF. The body diode of switch S_{w2} is forward biased. The input inductor Lᵢ releases the stored energy and voltage across the capacitor Cᵢ starts increasing through the diodes Dₒ₁ and Dₒ₂. The output inductors Lₒ₁ and Lₒ₂ release the stored energy through path 240 shown in FIG. 2B. This mode lasts until the instant t₃. The switching waveforms for the inductor and capacitor voltages are shown in FIG. 3 for which the expressions are written as follows:

V_{Li}=−2V_{dc}V_{Lo1}=V_{Lo2}=−V_{dc} (9)

i_{s1,2}=0i_{Do1,2}=i_{Li}+i_{Lo} (10)

where V_{dc} is the DC-link voltage of the BLSI Cuk PFC converter. During this mode, the expressions for the input and output inductor currents (i_{Li} and i_{Lo1,2}) are given as:

$${i}_{L i} ( t ) = - \frac{2 {V}_{d c}}{{L}_{i}} {t}_{off} + {I}_{Li 𝔪ax} \qquad ( 11 )$$

$${i}_{Lo 1 , 2} ( t ) = - \frac{{V}_{d c}}{{L}_{o 1 , 2}} {t}_{off} + {I}_{L 01 , 2 𝔪ax} \qquad ( 12 )$$

where I_{Limax} and I_{Lo1,2 max} are the input and output inductor currents at the end of Stage I, which are obtained using Equations (7) and (8) at tₒₙ=dTₛ. However, these currents are estimated at the end of Stage-II using Equations (11) and (12) at t_{off}=(1−d−d₁)Ts, where d₁ is the duration of Stage III, i.e. DCM.

FIG. 2C shows the flow path 250 of the third stage/mode (M-III). Stage III starts at time t₃, when both the switches remain in OFF state, as shown in FIG. 2C. The two currents through the input inductor Lᵢ and output inductor Lₒ₁ (and Lₒ₂) flow so that the current through output diodes Dₒ₁ and Dₒ₂ is zero. This mode is known as DCM or freewheeling mode. The waveforms for the duration t₃−t₄ are shown in FIG. 3 and the associated expressions are given as follows.

$${t}_{3} - {t}_{4} = {T}_{s} - \{ ( {t}_{2} - {t}_{1} ) + ( {t}_{3} - {t}_{2} ) \} \qquad ( 13 )$$

$${I}_{d c} = \frac{{V}_{d c}}{{R}_{L}} \qquad ( 14 )$$

where I_{dc} is the DC-link current and R_{L} is the effective resistive load for the BLSI Cuk PFC converter. The interval t₃−t₄ represents the DCM duration when none of the device is in conducting state.

DCM Operation

The design of both the Cuk and Buck converters is ensured in DCM to obtain the input current shaping without sensing it, unlike CCM operation. The design expression for different components is derived as follows.

BLSI Cuk PFC Converter Analysis in DCM

For DCM, the sum of switch ON and OFF durations should be less than the switching time,

tₙ+t_{off}<Tₛ (15)

Now equating the values of tₒₙ and t_{off} by volt second balance of input inductor Li from Mode-I and Mode-II, Equation (15) is simplified as,

$$d ( 1 + \frac{{V}_{i n}}{2 {V}_{d c}} ) < 1 \qquad ( 16 )$$

$$d ( 1 + \frac{1}{2 M} )$$

Therefore, the duty cycle for DCM operation is obtained as,

$$d < \frac{2 M}{2 M + 1} \qquad ( 17 )$$

where M is the BLSI Cuk PFC converter voltage gain. Based on the above relation, the voltage conversion ratio of the BLSI Cuk PFC converter is derived as,

$$M < \frac{1}{2} ( \frac{d}{1 - d} ) \qquad ( 18 )$$

It is to be noted that the voltage gain of the BLSI Cuk PFC converter is half than that of a typical buck-boost converter. Therefore, it operates at a higher duty cycle to provide the same DC-link voltage. Moreover, to operate it in high step-down gain configuration, the BLSI Cuk PFC converter voltage gain must follow the expression as, M<0.5 (19).

Output Average Current of BLSI Cuk PFC Converter

It is known that in steady-state, in a switching cycle, the average current through the capacitor is zero. Therefore, the average output current of the converter for one switching cycle is given as,

i_{dc,avg}=2<i_{d}> (20)

The expression for each diode current in Equation (20) is given as

i_{d}(t)=i_{Li}(t)+i_{Lo}(t) (21)

Using expressions for tog, input and output inductor currents in Mode-II, the converter average output current for one switching cycle, is given as,

$${i}_{d c , avg} = \frac{{V}_{in}^{2} {d}^{2} {T}_{s}}{{L}_{eq} {V}_{d c}} where \qquad ( 22 )$$

$$\frac{1}{{L}_{e q}} = \frac{1}{{L}_{i}} + \frac{1}{{L}_{o}} \qquad ( 23 )$$

Now the average output current over one line cycle is obtained as,

$${I}_{dcavg} = \frac{1}{π} {\int }_{0}^{π} {i}_{d c , avg} = \frac{{V}_{in}^{2} {d}^{2} {T}_{s}}{{L}_{eq} {V}_{d c}} \qquad ( 24 )$$

The normalized DC current for the BLSI Cuk PFC converter, is obtained using Equation (24) as,

$${I}_{dcn} = \frac{{d}^{2} {V}_{i n}^{2}}{{V}_{d c} {V}_{i n}} = \frac{{d}^{2} {V}_{i n}}{{V}_{d c}} = \frac{{d}^{2}}{M} \qquad ( 25 )$$

The operation of the converter in DCM is bounded using the duty cycle as obtained by Equation (18) and the normalized output current obtained by Equation (25), which shifts towards CCM as the load current increases.

Input Current of BLSI Cuk PFC Converter

Considering a lossless operation for the BLSI Cuk PFC converter, as

Pᵢₙ=PₒVᵢₙIᵢₙ=2V_{dc}I_{dc} (26)

Using Equation (24) to substitute the value of I_{dc,avg} for I_{dc}, the input current is obtained as,

$${I}_{i n} = \frac{2 {V}_{in} {d}^{2} {T}_{s}}{{L}_{e q}} \qquad ( 27 )$$

Selection of Inductances Lᵢ and L_{o1,2}

The inductor Lᵢ in the BLSI Cuk PFC converter also works as an input filter eliminating the need for an EMI filter. Therefore, the design of input inductor in continuous conduction mode is obtained by considering the ripple r in input current, as,

$$r {i}_{L i} = \frac{{V}_{i n}}{{L}_{i}} d {T}_{s} ⇒ {L}_{i} = \frac{{V}_{i n} {dT}_{s}}{r {i}_{L i}} \qquad ( 28 )$$

The value of inductance is selected higher than the calculated one to ensure the continuity in input inductor current. After estimating Lᵢ, the value of Lₒ is obtained using Equation (23) as,

$${L}_{e q} = \frac{{L}_{i} {L}_{o}}{{L}_{i} + {L}_{o}} \qquad ( 29 )$$

Using Equations (14) and (21), the value of Lₒ₁=Lₒ₂−Lₒ is obtained as,

$${L}_{e q} = \frac{4 {V}_{i n}^{2} {V}_{dc}^{2} {T}_{s}}{{{P}_{o} ( 2 {V}_{dc} + {V}_{i n} )}^{2}} \qquad ( 30 )$$

The output inductors of the BLSI Cuk PFC converter are selected to operate in DCM over one switching cycle so that the current through the output diode during the switching interval (t₂−t₃) is zero. The value of the output inductor is estimated according to Equation (29) and the selected value is sufficiently lower than the estimated one to achieve discontinuous current over a switching interval.

Selection of Capacitor Cᵢ

The capacitor Cᵢ is selected to operate in continuous conduction mode such as the voltage across the capacitor remains continuous over a switching interval. In some embodiments, the value of the capacitor is selected such as there is no low-frequency oscillation caused by the resonant circuit made by Lᵢ, Cᵢ, and Lₒ. The expression for selecting the capacitance is given as

$${C}_{1 , 2} = \frac{1}{{ω}_{r}^{2} ( {L}_{i} + {L}_{o} )} \qquad ( 31 )$$

The frequency for this resonant circuit should follow the expression, as

f<fᵣ<fₛ, (32)

where f is the line frequency, fᵣ is the resonant frequency in Hz, and fₛ is the switching frequency in Hz.

Selection of Capacitor C_{dc}

The rating of DC-link capacitor C_{dc} is selected based upon the power P and voltage ripple Δ. To minimize the ripple in battery current at the next stage, the DC-link capacitor C_{dc} for the BLSI Cuk PFC converter is obtained using the expression, as,

$${C}_{dc} = \frac{{I}_{dc}}{2 {ω}_{L} {Δ V}_{dc}} = \frac{( \frac{P}{{V}_{dc}} )}{2 {ω}_{L} {Δ V}_{dc}} = \frac{P}{2 {ω}_{L} {Δ V}_{dc}^{2}} \qquad ( 33 )$$

where ωL represents the line frequency in rad/sec and A is the permissible ripple in DC link voltage.

Selection of Buck Converter Inductance Lin

The inductor Lᵢₙ of the buck converter is designed to operate in DCM to reduce the sensing requirement in the circuit. Considering a ripple r twice the average current, the value of inductor Lᵢₙ is estimated as,

$${L}_{i n} = \frac{{V}_{dc} D}{2 {I}_{dc} {f}_{s b}} = \frac{{R}_{b} D}{2 {f}_{s b}} = ( \frac{{V}_{dc}^{2}}{{P}_{o}} ) \frac{D}{2 {f}_{s b}} \qquad ( 34 )$$

where f_{sb} is the switching frequency for the buck converter switch, R_{b} is the effective resistive load at the battery end, and D is the duty cycle needed for the buck converter to provide 65V at the battery end.

The BLSI Cuk Buck charger 100 may be configured as a fast (type-II) on-board EV charger, as a slow (type-I) on-board EV charger, or as an off-board charger. To configure the BLSI Cuk Buck charger as a slow charger, the size of the DC-link C_{dc} size may be reduced from about 2200 μF/400V, and/or film capacitors used instead of electrolytic capacitors.

Control of BLSI Cuk Buck EV Charger

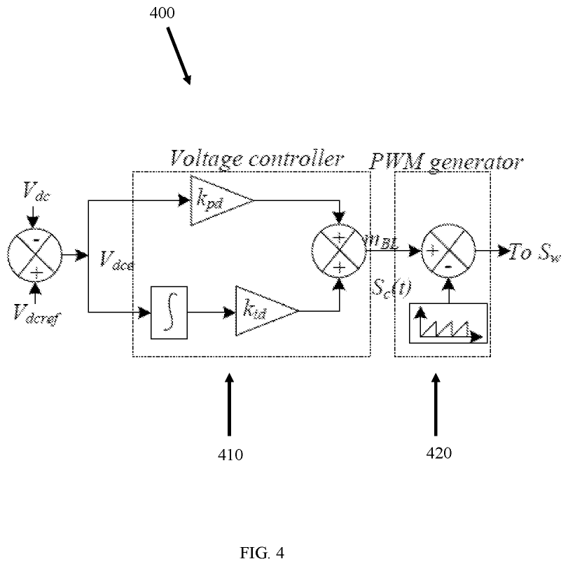

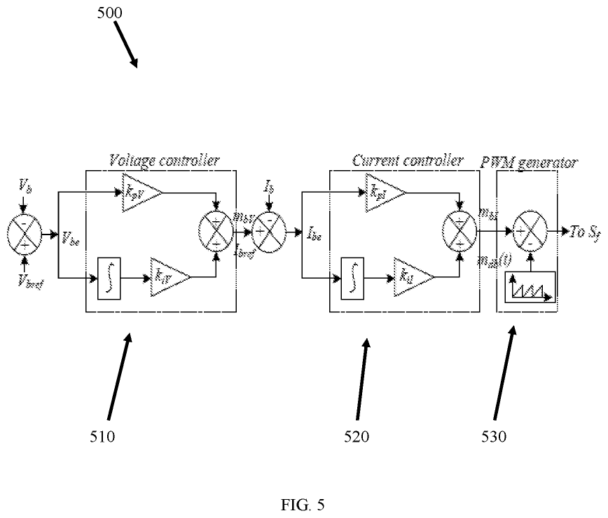

The control of the BLSI Cuk Buck EV charger is achieved under two subparts: control of the BLSI Cuk PFC converter for unity power factor (UPF) operation utilizing the switches S_{w1,2} to full capacity (see e.g., FIG. 4) and control of buck converter to facilitate increased charging current to the battery (see e.g., FIG. 5).

FIG. 4 is a diagram of a control unit 400 of the BLSI Cuk converter in DCM operation. The controller 400 includes a voltage controller 410 and a PWM generator 420. Voltage controller 410 is a proportional-integral (PI) controller. In some embodiments, two objectives of the controller 400 are to regulate the DC-link voltage of the BLSI Cuk PFC converter and/or to provide unity PF operation over the complete range of supply voltage. The DC-link voltage of the BLSI Cuk PFC converter feeds the buck converter at the battery end. In some embodiments, the DC-link voltage of the BLSI Cuk PFC converter is controlled at 200V. This DC-link voltage utilizes the switch voltage to its maximum rating of 800V, 60A. An inherent PFC capability at the mains is achieved with this DCM based design. However, to control the DC-link voltage at a given value, the output voltage V_{dc} is sensed and compared to the reference voltage V_{dcref}. The error V_{dce} is then passed to a proportional-integral (PI) controller 410, which gives a control signal m_{BL} at the output For kₜₕ sampling instant, the expression for error (Equation (36)) and the output of PI controller 410 (Equation (35)) is given as:

V_{dce}(k)=V_{dcref}(k)−V_{dc}(k) (35)

m_{BL}(k)=m_{BL}(k−1)+k_{pd}{V_{dc}(k)−V_{dc}(k−1)}+k_{id}V_{dc}(k) (36)

where k_{pd} and k_{id} are the proportional and integral constant of PFC controller 510. This control signal is then given to the PWM comparator 520 to obtain the pulse for the BLSI Cuk PFC converter, such as the converter switches are utilized to full capacity. Both the switches are turned ON and turned OFF simultaneously during each half-cycle, which makes the implementation of the control circuit simpler.

FIG. 5 is a diagram of a buck controller 500 with CC/CV control implementation through Dual PI control. The objective of buck controller 500 is to control the output voltage at 65V such as the battery current is higher than for the typical case. Therefore, the buck controller 400 is a cascaded dual-loop PI controller that achieves this objective such that constant current-constant voltage (CC-CV) based charging is facilitated for the EV battery. The battery voltage V_{b} and current I_{b} are sensed and given to the voltage and current PI controllers 410, 420. When the battery state of charge (SOC) is less than 80%, the current controller 420 operates and the battery is charged in CC mode. After the comparison of sensed battery current I_{b} and reference battery current I_{bref}, an error I_{be}, is obtained. The reference for the current loop is set by the output of voltage PI controller 410 which is disabled during CC mode. The battery current error is given as an input to the current PI controller. The output of current PI controller 420, m_{bl}, drives the PWM comparator 430 to provide the required pulses to buck converter switch. As soon as the battery SOC hits more than 80% range, the dual loop controller switches to CV mode. The controller exits CC mode as the current controller saturates. The voltage PI controller 410 becomes active and the sensed battery voltage, V_{b} is compared to the reference voltage V_{bref} and error V_{be} is obtained. The error signal V_{be} drives the input of voltage PI controller 410 and the control signal, m_{bV} is obtained at the output. Control signal m_{bI} is given to the PWM comparator 430 to generate the duty ratio for buck converter switch. It is to be noted that during this charging phase, the battery current is reduced to a much lower value than that in CC mode. Because the same switch is used, the charge time for battery using the BLSI Cuk PFC converter based fast charger, is one-fourth the charge time of the typical buck-boost single-stage converter based slow charger.

Simulation Studies of the BLSI Cuk PFC Converter

Simulation studies of the BLSI Cuk PFC Converter and typical buck boost EV chargers were conducted and were directed to charging a 48V, 100Ah battery. In these studies, the battery was simulated as charging at 0.13C rate (13A) in constant current (CC) mode and all the input and output specifications were kept the same.

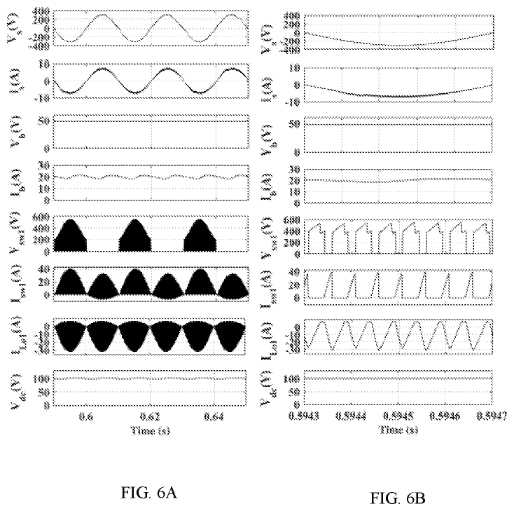

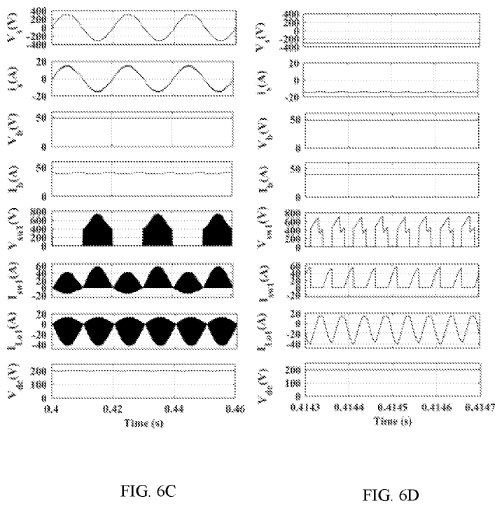

FIGS. 6A-D are graphs showing the steady-state performance of the BLSI Cuk PFC converter based fast charger with maximum utilization of switches capacity at the PFC stage. FIGS. 6A-B show that the BLSI Cuk PFC converter incurs only a peak voltage and current stress of 580V, 40A for the same power range. Therefore, in some embodiments, the BLSI Cuk PFC converter is used to extend the delivered power by increasing the operating voltage and current range of switches. The DC-link voltage is increased from 65V in the previous case, to 100V for 1 kW and 200V for 2 kW rating, as shown in FIGS. 6C-D.

It is observed that, for the BLSI Cuk Buck charger disclosed herein, the delivered power is extended to 2 kW from 1 kW with twice the increase in DC-link voltage and four times increase in the battery current, when compared to typical buck-boost converter based chargers.

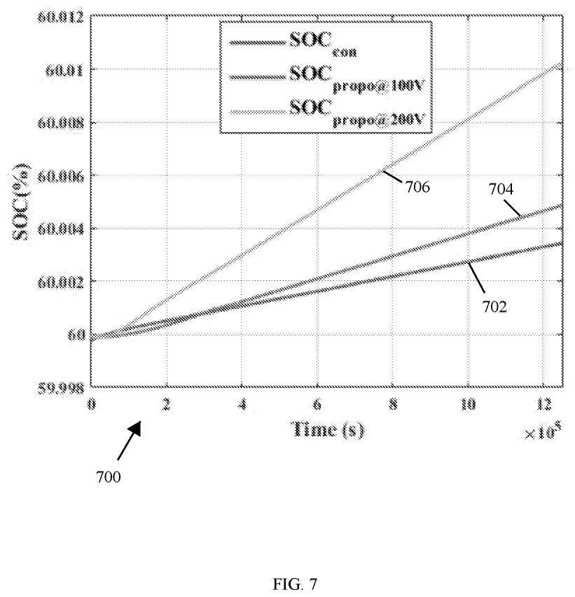

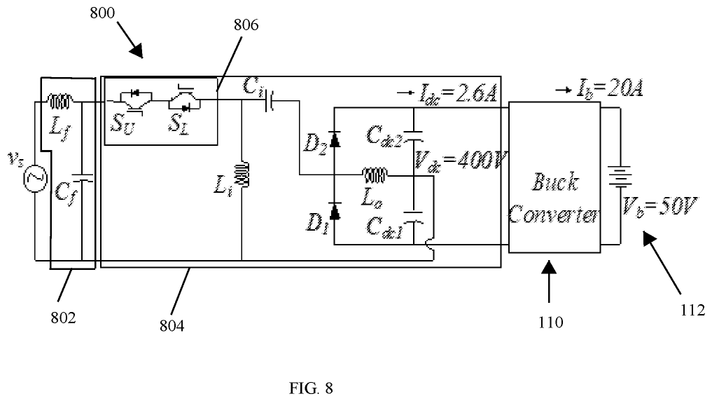

FIG. 7 is a graph 700 that illustrates a comparison of battery SOC rates of a typical buck boost EV charger (line 702), the BLSI Cuk Buck charger at a DC-link voltage of 100V (for 1 kW) (line 704), and the BLSI Cuk Buck charger at a DC-link voltage of 200V (for 2 kW) (line 706). As can be seen, the battery charging time of the BLSI Cuk Buck charger is four times faster than the typical EV charger because the power delivered by the BLSI Cuk Buck charger is greater than the typical EV charger even though the device rating is the same. In other words, during the same time interval, the rise in SOC is greater with the BLSI Cuk Buck charger, so the battery takes less charging time.

I.B. BL Zeta Buck Charger

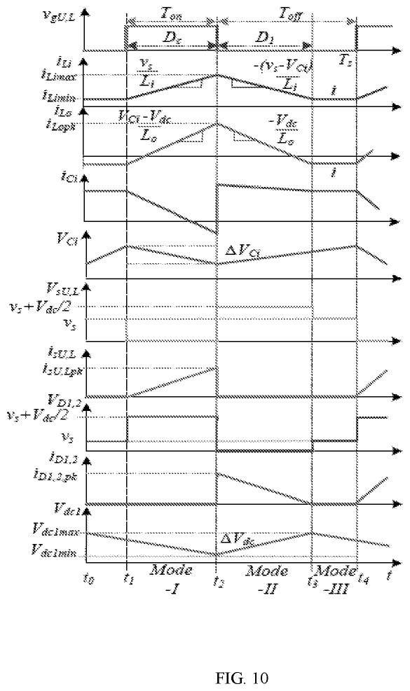

FIG. 10 is a circuit diagram of a bridgeless (BL) Zeta Buck charger 800 for charging a battery, according to some embodiments. The BL Zeta Buck charger 800 includes an EMI filter 802 connected to a BL Zeta power factor correction (PFC) converter 804, which is connected to a buck converter 110. The buck converter 110 is configured to be connected to the positive and negative terminals of the battery V_{b} 112. The buck converter 110 is utilized to control the current through the battery during fast charging. The buck converter 110 includes a buck inductor L_{b} (not shown).

The EMI filter 802 includes a filter inductor L_{f} and a filter capacitor C_{f}. One end of the filter inductor L_{f} is connected to AC input source vs and the other end is connected to a node to which the filter capacitor C_{f} and switch 806 of the BL Zeta PFC converter 804 are connected.

The BL Zeta PFC converter 804 includes a switch 806 with upper switch Su and lower switch S_{L} in series, an input inductor Lᵢ, a transfer capacitor Cᵢ, diodes D_{1,2}, an output inductor Lₒ, and DC link capacitors C_{dc1,2}. The BL Zeta PFC converter 804 has a first node where the switch 806, an and of input inductor Lᵢ and the positive side of transfer capacitor Cᵢ are connected, a second node where the negative side of transfer capacitor Cᵢ, the anode of diode D₂, the cathode of diode D₁, and an end of output inductor Lₒ are connected, a third node where the cathode of diode D₂, the positive side of DC link capacitor C_{d2}, and the buck converter 110 are connected, a fourth node where the anode of diode D₁, the negative side of DC link capacitor C_{dc1} and the buck converter 110 are connected, and a fifth node where the negative side of DC link capacitor C_{dc2}, the positive side of DC link capacitor C_{dc2}, an end of output inductor Lₒ, a second end of input inductor Lᵢ, the negative side of filter capacitor C_{f}, and to the AC source vs are connected.

The input inductance Lᵢ, output inductance Lₒ and transfer capacitor Cᵢ are shared during positive and negative half cycle operations. During operation of the BL Zeta Buck charger, the input inductor Lᵢ and transfer capacitor Cᵢ operate in CCM mode while the equivalent inductance L_{eq}, the output inductor Lₒ, and the buck inductor L_{b} operate in DCM mode. Table 1 provides equations for components of the BL Zeta Buck charger.

TABLE 1
Equations for Components of the BL Zeta PFC Buck charger

| Component of BL Zeta Buck | |
|---|---|
| Charger | Equation |
| Input Inductor Lᵢ | ${L}_{i} = ( \frac{{V}_{i n} {T}_{s}}{δ {I}_{i n}} ) \cdot ( \frac{{V}_{d c}}{2 {V}_{i n} + {V}_{d c}} )$ |
| Equivalent Inductance L_{eq} | ${L}_{e q} = \frac{{V}_{i n}^{2} {V}_{d c}^{2} {T}_{s}}{4 {P ( {V}_{d c} + 2 {V}_{i n} )}^{2}}$ |
| Output Inductor Lₒ | ${L}_{o} = \frac{{L}_{i} {L}_{e q}}{{L}_{i} - {L}_{e q}}$ |
| Transfer Capacitor Cᵢ | ${C}_{i} = \frac{1}{{( 2 π {f}_{r} )}^{2} ( {L}_{i} + {L}_{o} )}$ |
| Maximum Filter Capacitance C_{fmax} of the Filter Capacitor C_{f} | ${C}_{f max} = \frac{P \cdot tan θ}{{( 2 π f \cdot {V}_{s}^{2} )}^{2}}$ |
| Filter Inductor L_{f} | ${L}_{f} = [ \frac{1}{4 {π}^{2} {f}_{c}^{2} {C}_{f}} ] - [ \frac{0.4 \cdot {V}_{s}^{2}}{2 π f \cdot P} ]$ |
| DC link Capacitor C_{dc1,2} | ${C}_{d c 1 , 2} = \frac{{I}_{d c}}{2 \times 2 π f {Δ V}_{d c}} = \frac{P}{4 π {f V}_{d c} {Δ V}_{d c}}$ |
| Buck Inductor L_{b} | ${L}_{b} \leq {L}_{b c} = \frac{{V}_{b} ( 1 - {D}_{b} ) {T}_{s}}{2 {I}_{b}}$ |
| Output Capacitor C_{b} | ${C}_{b} = \frac{{D}_{b} {V}_{b}}{{f}_{s w} ( \frac{{V}_{b}^{2}}{P} ) {λ V}_{b}}$ |

where Tₛ is the switching period of the BL Zeta PFC converter, δ is the permissible current ripple in the input inductor, P is the output power, θ is displacement angle between source voltage and current, Δ is the permissible voltage ripple in the DC link capacitor, V_{b} is the battery voltage, I_{b} is the battery current, f_{sw} is the switching frequency of the buck converter, and λ is the permissible voltage ripple in the output capacitor C_{b}.

The voltage gain is represented by:

$$\frac{{V}_{dc}}{{V}_{i n}} = \frac{2 D}{( 1 - D )} = M \qquad ( 37 )$$

In some embodiments, the BL Zeta PFC converter voltage gain is greater than 2 (M>2).

The BL Zeta PFC converter 804 uses a split capacitor at the output, which facilitates lower switch voltage stress (i.e. Vᵢₙ+V_{dc}/2), as compared to a typical BL Zeta converter (i.e. Vᵢₙ+V_{dc}). Another advantage of the BL Zeta charger is achieved with the operation of the BL Zeta PFC converter at increased DC-link voltage, as compared to typical single-stage EV chargers. The operation of BL Zeta PFC converter at higher DC-link voltage ensures reduced DC-link capacitance, comparatively, as the capacitance value is inversely proportional to the output voltage. Therefore, in low-power charger applications, the bulky electrolytic capacitors can be replaced with film capacitors, that have better reliability.

The BL Zeta Buck charger 800 may be configured as a fast (type-I) on-board EV charger, as a slow (type-I) on-board EV charger, or as an off-board charger. To configure the BL Zeta Buck charger as a slow charger, the size of the DC-link C_{dc} size may be reduced from about 2200 μF/400V, and/or film capacitors used instead of electrolytic capacitors. The BL Zeta PFC converter 804 may form a part of an on-board EV charger, an off-board EV charger, or another type of charger.

Benefits of the BL Zeta PFC converter 804 include incurring lower switch voltage stress and comparable current stress compared to typical BL Zeta PFC converters such that lower rating devices are required, using a fewer number of components as compared to the typical BL topologies based on Cuk, SEPIC and Zeta converters, operating at increased DC-link voltage which reduces the cost of using electrolytic capacitors, significantly reducing battery charging time (almost 8 times faster) compared to typical BL Zeta converter based slow chargers, operating the BL Zeta PFC converter in DCM which utilizes a control system that is less complex due to the use of fewer sensors, as compared to typical converters which require CCM operation and hence, more sensors, to operate in a high power range.

In some embodiments, the BL Zeta PFC converter disclosed herein has an input voltage of 90-130V (110V, nominal value), single-phase AC, a change in output voltage/current V_{ac}/I_{dc} of 300-400V/2.6A, and a switching frequency fₛ of 20 kHz. In comparison, a prior art buck converter has an input voltage of 400 V, DC, a change in output voltage/current V_{ac}/I_{dc} of 48V/20A, a switching frequency fₛ of 50 kHz.

In further embodiments, the BL Zeta PFC charger an output power P of 1 kW, a permissible current ripple δ in the input inductor of 20%, a permissible voltage ripple Δ in the DC-link capacitor of 3%, and a permissible voltage ripple λ in the output capacitor of 1%.

Operating Stages/Modes of BL Zeta PFC Converter

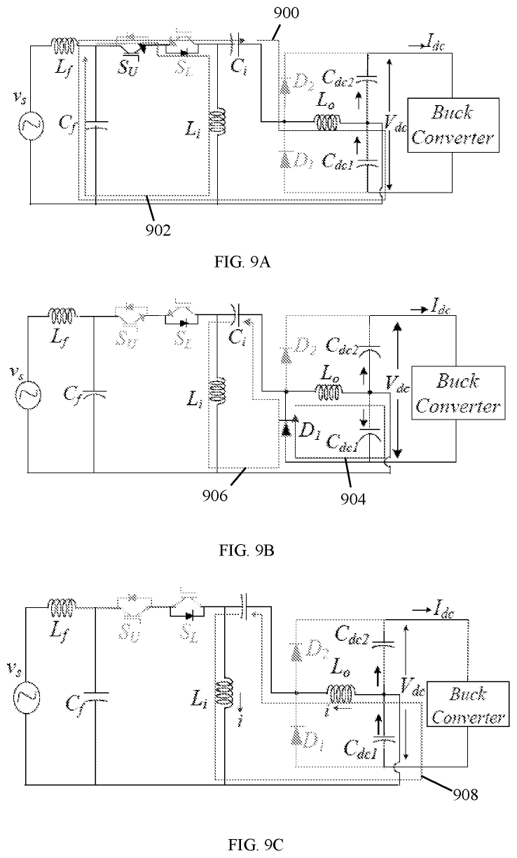

FIGS. 9A-C illustrate different operating modes of the BL Zeta PFC converter, switch ON (Stage-I), switch OFF (Stage-II), and DCM period (Stage-III), respectively, and FIG. 10 are waveform diagrams illustrating switching waveforms over one Tₛ, of positive line cycle.

FIG. 9A shows the flow paths 900, 902 of the first stage/mode (M-1). During the first mode (Mode-I), the upper device and lower body diode of the bidirectional switch is turned ON. In this mode, the diode D₁ is in a non-conducting state and the inductors Lᵢ and Lₒ start charging storing the energy from the supply, as shown in FIG. 9A and FIG. 10. The DC-link capacitors C_{dc1} and C_{dc2} supply the current to the buck converter at Mode-II. During Mode-I, the current i_{Li} is described by

$$\frac{{v}_{s}}{{L}_{i}}$$

and current i_{Lo} is described by

$$\frac{{V}_{C i} - {V}_{dc}}{{L}_{o}} .$$

FIG. 9B shows the flow paths 904, 906 of the second stage/mode (M-II). During the second stage (Mode-U), the upper switch S_{U} is turned OFF and the diode D₂ comes into conduction. Capacitor Cᵢ starts charging as the inductor, Lᵢ releases the stored energy through Cᵢ. Furthermore, the energy stored in Lₒ is transferred to C_{dc1} so that it gets charged, while C_{dc2} keeps discharging during this period, as shown in FIG. 10. During Mode-U, current i_{Li} is described by

$$\frac{- ( {v}_{s} - {V}_{Ci} )}{{L}_{i}}$$

and current i_{Lo} is described by

$$\frac{- {V}_{dc}}{{L}_{o}} .$$

FIG. 9C shows the flow path 908 of the third stage/mode (M-III). During the third stage (Mode-HI), the current in the input and output inductors in opposite directions but with equal magnitude such as the conduction in the diode D₁ is stopped. The BL Zeta PFC converter enters into a discontinuous stage. The two output capacitors supply the load current at this instant Similar three modes are observed during the negative half of the supply cycle, with lower switch, upper switch body diode, and the diode D₂.

Control of BL Zeta PFC Converter

FIGS. 11A-B are illustrations of the topology of control circuits for the BL Zeta PFC converter, according to some embodiments. As can be seen in FIG. 11A, the controller uses a voltage follower approach without the need for PLL or input side sensing. As can be seen in FIG. 11B, control of the buck converter is implemented by a cascade controller for regulating the batter current during constant current and constant voltage charging. Control of the BL Zeta PFC converter in DCM is achieved using the voltage feedback-based PWM control. Control of the buck converter for regulating the current in the EV battery during CC-CV mode is achieved using a dual-loop PI control. The error and output of the two converter controllers, for the nth sampling instant, are given as follows:

V_{dce}(n)=V_{dcref}(n)−V_{dc}(n) (38)

m_{BL}(n)=m_{BL}(n−1)+K_{pd}{Vₑ(n)−Vₑ(n−1)}+K_{id}·Vₑ(n) (39)

where V_{dce} is the error voltage between the set DC link voltage V_{dcref} and sensed DC link voltage V_{dc}, with K_{pd}, K_{id}, and m_{BL} taken as a proportional constant, an integral constant, and the output of the voltage controller, respectively. The control signal, m_{BL} (the output of the voltage controller), is compared to an internally generated triangular wave, S_{c} that is being switched at converter switching frequency such that pulses are produced following pattern as:

If S_{c}<m_{BL}m_{BL},then S_{U,L}=ON Otherwise,S_{U,L}=OFF (40)

where, S_{U,L} denotes the gate signals for switch S_{U,L}, which controls the required duty cycle for any variation in input voltage during the entire charging process. Similarly, for the buck converter, the error and control signal for the two loops are given as:

I_{be}(n)=I_{bref}(n)−I_{b}(n) (41)

m_{bI}(n)=m_{pI}(n−1)+K_{pI}{I_{be}(n)−I_{be}((n−1)}+K_{iI}·I_{be}(n) (42)

V_{be}(n)=V_{bref}(n)−V_{b}(n) (43)

m_{bV}(n)=m_{bV}(n−1)+K_{pV}{V_{be}(n)−V_{be}(n−1)}+K_{iV}·V_{be}(n) (44)

Here, I_{be} is the difference between sensed battery current (I_{b}) and reference battery current (I_{bref}), with K_{pI}, K_{iI} and m_{bI} taken as proportional constant, integral constant, and the output of the current controller, respectively. Similarly, V_{be} is the error voltage between the set battery voltage V_{bref} and sensed battery voltage V_{b}, with K_{pV}, K_{iV}, and m_{bV}, taken as proportional constant, integral constant, and the output of the voltage controller, respectively. For the SOC value of 80%, CC charging is facilitated to the battery. However, as the SOC exceeds this value, the battery charging shifts to CV mode. During CC mode, a constant current is taken by the battery from the supply. However, CV mode is identified with a reduced current taken from the source, till the battery voltage rises to the completely charged state. The length of DCM duration depends upon the switching pattern, over which, the improved PQ operation of the BLSI Cuk Buck charger is ensured satisfactorily. For any dynamic that appears in the circuit during the operation, the pulse width of the switch is varied in proportion to the error generated in each sampling instant.

Simulation Studies of the BL Zeta PFC Converter

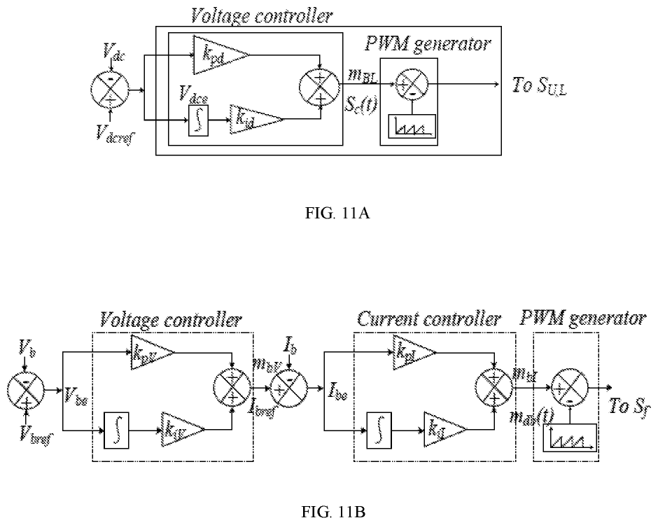

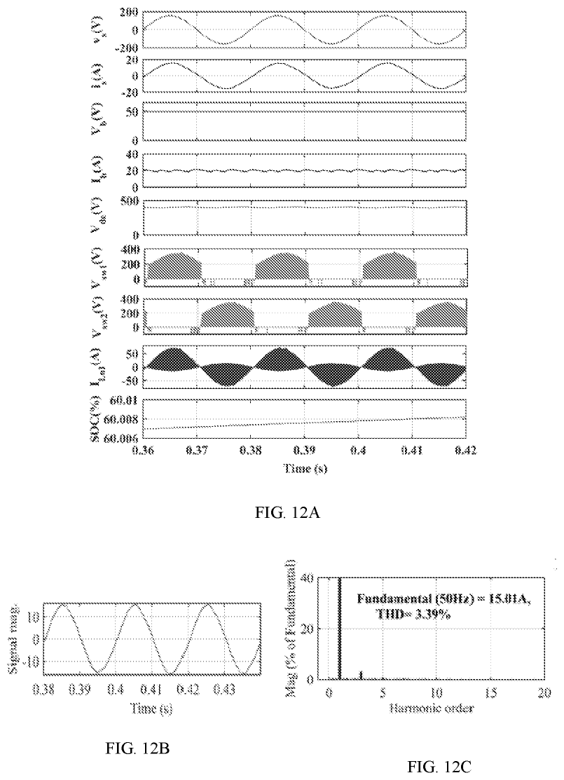

The performance of the BL Zeta PFC charger at steady-state and rated voltage is shown in FIG. 12A. The DC-link voltage of the BL Zeta PFC converter is controlled at a constant 400V, which feeds the buck converter at the next stage. The battery is charging in CC mode with a constant current of 20 A, which is almost eight times faster than the typical slow chargers (2.6A). The steady-state operation of BL Zeta PFC converter in DCM is demonstrated when the current through Lₒ becomes discontinuous over a single switching period. The switches incur a peak voltage stress of 365V which verifies as per the specification (Vᵢₙ+V_{dc}/2). The BL Zeta PFC converter 240 as has a voltage stress of 365V, which is much lower than the voltage stress of 555V for typical BL converters (110 \sqrt{2}V+400V=555V). As can be seen in FIG. 12B, the BL Zeta PFC converter 804 achieves unity power factor line current FIG. 12C shows that the BL Zeta PFC converter 804 has improved PQ indices.

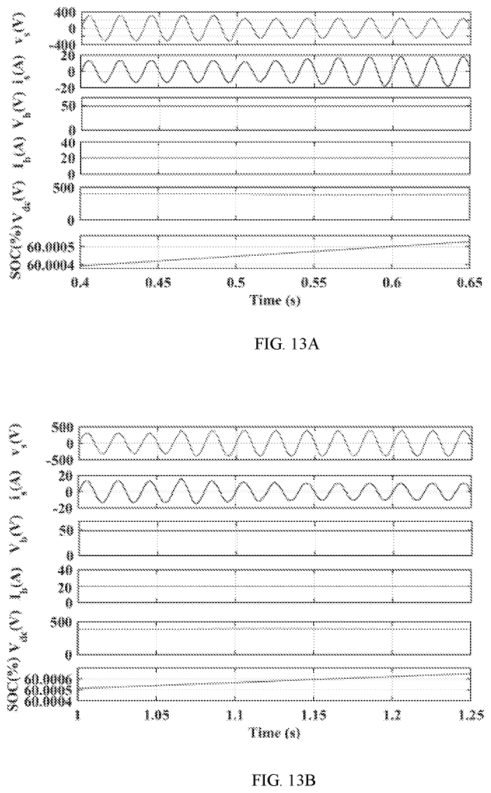

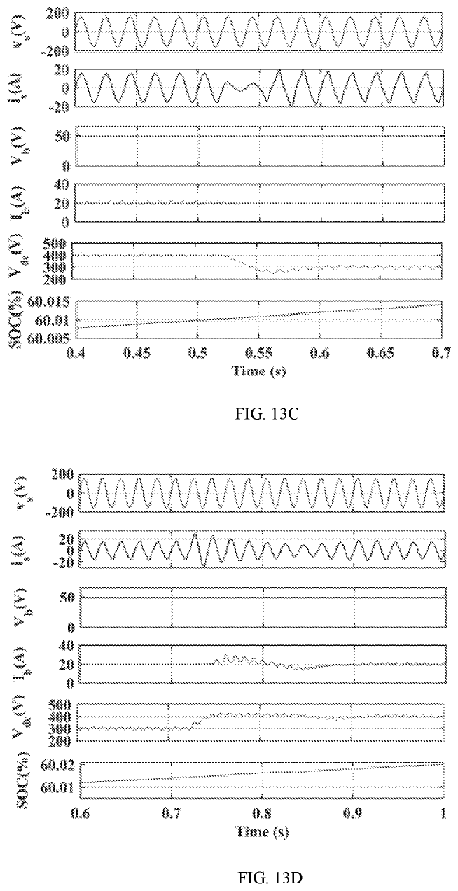

FIGS. 13A-D illustrate the performance of the BL Zeta Buck charger with variations in the line voltage from 110-90V (FIG. 13A), variations in the line voltage from 110-130V (FIG. 13B), during a change in DC-link voltage V_{dc} from 400-300V (FIG. 13C) and during a change in DC-link voltage V_{dc} from 300-400V (FIG. 13D).

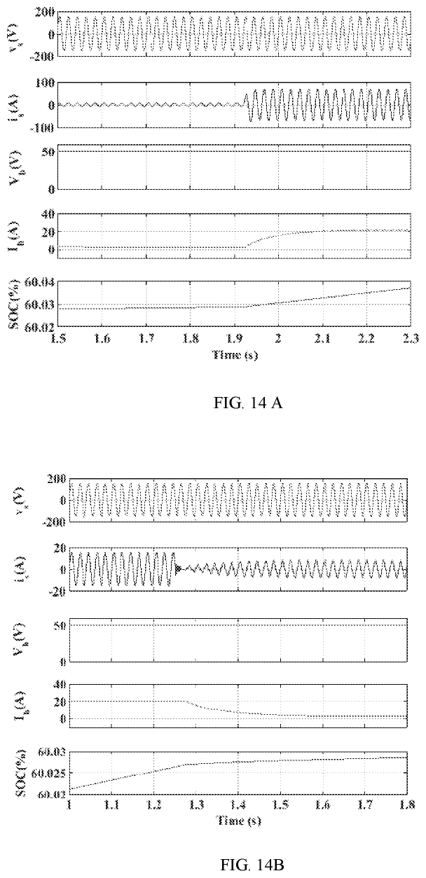

FIGS. 14A-B illustrate the recorded performance of the BL Zeta Buck charger under startup and shut down processes, respectively. The change in waveforms of supply voltage vₛ, supply current iₛ, battery voltage V_{b}, and battery current I_{b}, during these transients is controlled by digital signal processor (DSP) commands. The charging of the battery in CC mode is observed with a constant current of 20 A, as the battery is in a completely discharged state, during which battery voltage is observed as 46V. To record the performance during startup, a transition in battery reference voltage is given through the controller from 46V to the rated open-circuit voltage of the charger, i.e. 65V. It is seen that the battery current has no inrush during the sudden start of the charging process. A rise in battery current from zero to 100% value is seen, which shows the soft-start of the charger. The vice versa case is seen for the shut-down characteristics shown in FIG. 14B.

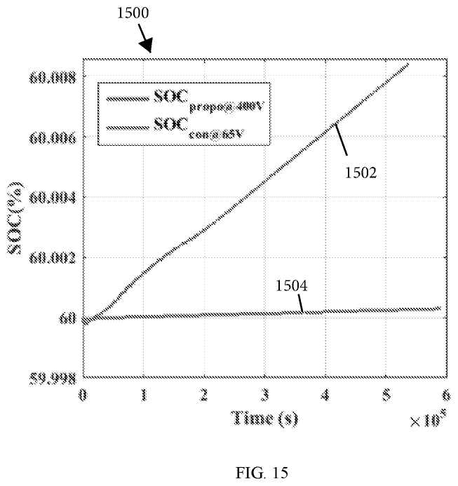

FIG. 15 is a graph 1500 showing a performance comparison of battery charge time with the BL Zeta Buck charger at 400V (line 1502) and a typical single-stage BL zeta converter based charger at 65V (line 1504). As can be seen, the battery state of charge (SOC) for the BL Zeta Buck charger rises much faster than for the typical single-stage BL Zeta converter based charger. This implies that to achieve the same SOC, the BL Zeta Buck charger takes less time compared to the typical slow charger.

II. Simultaneous AC and DC EV Charging

II.A. Converter and Inlet Port Configurations for Simultaneous AC and DC EV Charging

Typically, the PV generation and battery storage system have DC output voltage lower than the EV battery voltage. For simultaneous AC and EV charging, an off-board DC-DC converter is used to match the battery voltage and to control the charging current from a DC source such as PV generation, a battery storage system. In some embodiments, the off-board DC-DC converter is designed according to the power rating of the available DC power from the photovoltaic (PV) generation and battery storage system. In further embodiments, changes in charging control logic are implemented.

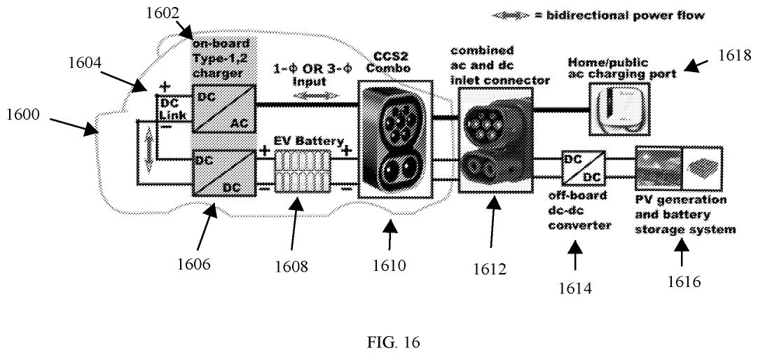

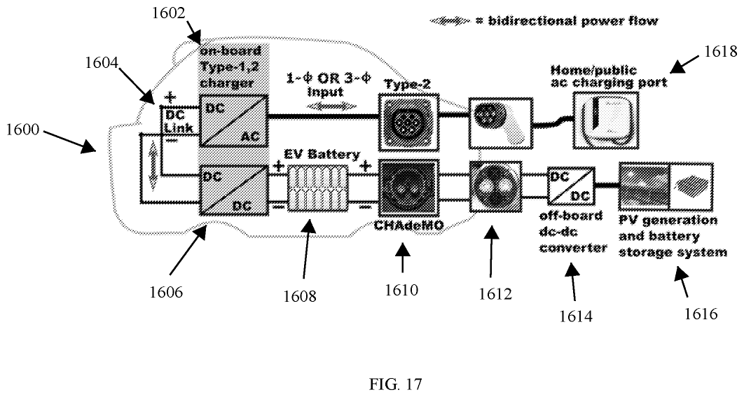

FIGS. 16-17 illustrate a simultaneous AC and DC EV charging system, according to some embodiments. The simultaneous charging system includes an EV 1600 and a charging connector 1612. The EV 1600 includes either a type-1 or type 2 on-board charger 1602, a DC/DC converter 1606 connected to the battery 1608, a DC Link 1604 connecting the on-board charger and the DC/DC converter 1606, and a charging port 1610. In some embodiments, the on-board charger includes an AC-DC power factor correction (PFC) rectifier.

The charging port 1610 is configured to accept power simultaneously from the home/public charging ports 1618 and a DC source 1616, such as a PV generator and/or battery storage system. In some embodiments, the charging port 1610 is in electrical communication with a charging connector 1612 that supplies power simultaneously from the home/public charging ports 1618 and a DC source 1616. In at least one embodiment, a DC/DC converter 1614 is used as an interface between the charging connector 1612 and the DC source 1616.

In one embodiment, the charging port 1610 is a CCS2 combo inlet charging port (see FIG. 16). In this example, both the charging port 1610 and the charging connector 1612 are unitary (single-piece construction). In another embodiment, the charging port 1610 is a type-2 and CHAdeMo connector (see FIG. 17). In this example, both the charging port 1610 and the charging connector 1612 are formed of two separate pieces.

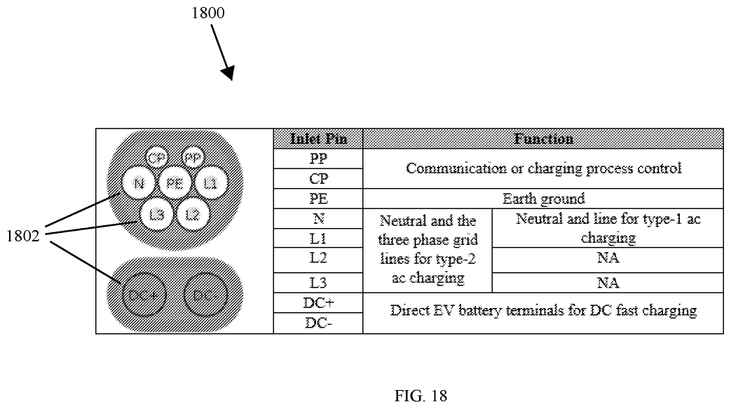

FIG. 18 is a graphic 1800 illustrating and describing an exemplary pin layout for a CCS2 combo EV charging port. The CCS2 combo charging port has a plurality of pins 1802. The plurality of pins includes pins for communication or charging process control (PP and CP), earth ground (PE), neutral and three-phase grid lines for type-2 AC charging (N, L1, L2, L3), neutral and line for type-1 AC charging (N), pins for DC fast charging (DC+, DC−). An EV charging connector with these pins and/or pin layout can be used to charge an EV with AC (single-phase or three-phase) and DC.

Control Strategy

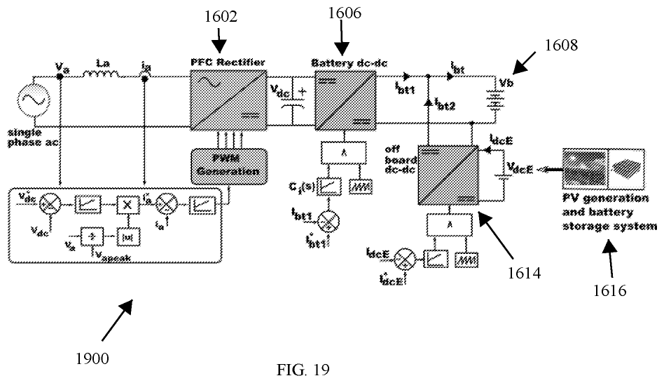

FIG. 19 illustrates a schematic of a control strategy 1900 for a simultaneous AC and DC EV charging system, according to some embodiments. In this example, the on-board EV battery charger 1602 is a type-1 EV battery charger with an AC-DC power factor correction (PFC) rectifier in electrical communication with the on-board DC-DC converter 1606. The output of the DC-DC converter is connected to the terminals of the battery 1608. For a single-phase low power scenario, the PFC rectifier is operated in voltage control mode with unity power factor to regulate the DC link voltage, and the on-board battery side DC-DC converter 1606 is operated in current control mode to charge the EV battery 1608. The off-board DC-DC converter 1614, connecting to the PV generation and battery storage system output directly to the terminals of the EV battery 1608, is controlled in current control (CC) mode to charge the EV battery.

Simulations

Simulations in MATLAB/Simulink were conducted on a simultaneous AC and DC EV charging system with a type-1 on-board charger. Table 2 provides the simulation parameters for the on-board type-1 AC charger and the off-board DC-DC converter:

TABLE 2
Simulation Parameters for the simultaneous
AC and DC EV charging systems

| | |
|---|---|
| Simulation Parameter | Value |

On-Board Type-1 PFC Rectifier

| | | |
|---|---|---|
| Input Single Phase AC Voltage | 230 | V |
| Output Power (Pₒ₁) | 3.3 | kW |
| DC Link Capacitor (C₁) | 1200 | μF |

On-Board Battery Side DC-DC

| | | |
|---|---|---|
| DC Link Voltage (V_{dc}) | 600 | V |
| Output Capacitor (Cₒ) | 800 | μF |
| Filter Inductor (L_{f}) | 7.8 | mH |
| Battery Voltage (V_{bt}) | 400 | V |
| Battery Energy Rating (E_{bt}) | 40 | kWh |

Off-Board DC-DC Converter

| | | |
|---|---|---|
| Input DC Voltage Range (V_{dcE}) | 150-300 | V |
| Filter Inductor (L₁) | 4 | mH |
| Output Capacitor (Cₒ₁) | 1200 | μF |

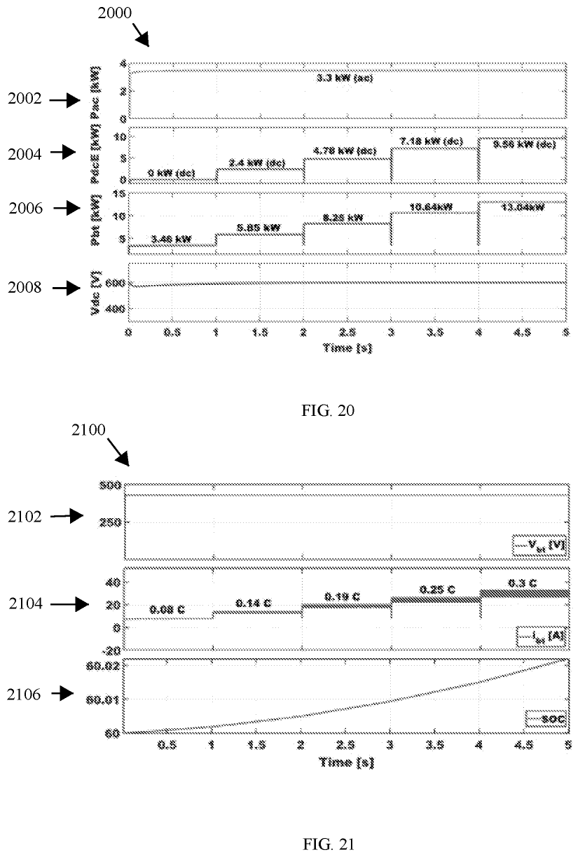

The Type-1 AC charger is rated at 3.3 kW, whereas, the off-board DC-DC converter is operated in current control mode (CCM) with a maximum operating power of 10 kW. FIG. 20 is a graph 2000 showing the simulation results for simultaneous AC and DC charging of an EV. Graph 2000 shows the type-1 on board charger output power P_{ac} (kW) in graph 2002, the off-board DC-DC converter output power P_{dc} (kW) in graph 2204, the total battery charging power P_{bt} (kW) in graph 2006, and the DC link voltage V_{dc} (V) of the type-1 on board charger in graph 2008. The EV battery was charged from type-1 AC charger alone at a 0.08 C rating from 0 to 1 second. From 1 to 2 seconds, EV battery is supplied with 2.4 kW power from additional DC source in addition to the constant 3.3 kW from type-1 AC charger, which increased the charging rate of EV battery to 0.14 C rating. Further battery charging at 0.19 C, 0.25 C, and 0.3 C rating is achieved by increasing the current reference of the off-board DC-DC converter.

FIG. 21 is a graph 2100 showing the voltage V_{bt} (V) (graph 2102), the current &br (A) (graph 2104), and the battery state of charge SoC (graph 2106), and for the different current reference of the battery side DC-DC converter is shown in FIG. 21.

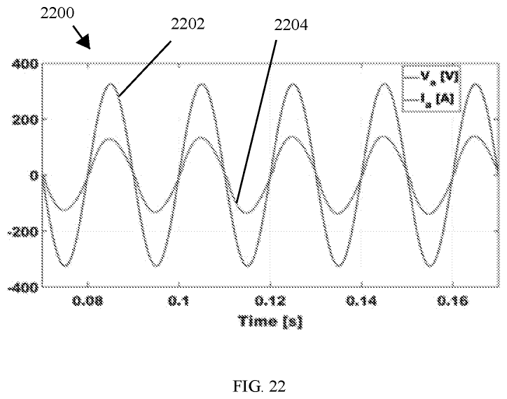

FIG. 22 is a graph 2200 showing the in-phase grid voltage Vₐ (V) (line 2202) and current value Iₐ (A) (line 2204) for a PFC rectifier stage of a type-1 on-board charger operated with unity power factor at the grid. Iₐ is scaled 6 times for better clarity. Relative to the type-1 charger alone charging the EV battery, the additional DC source from PV generation and battery storage system increases the rate of charging in proportion to its max power rating.

II.B. Simultaneous AC and DC EV Charging Using the EV Drivetrain

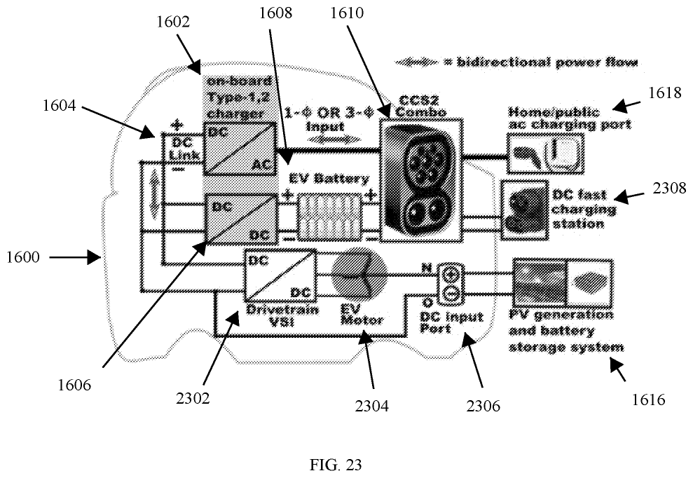

FIG. 23 shows another embodiment of a system for simultaneous AC and DC charging that includes an EV 1600 and charging sources 1616, 1618, and 2308. The EV 1600 includes a type-1 or type-2 on-board charger 1602, an on-board DC-DC converter 1606, a DC Link 1604, a battery 1608, a charging port 1610, a drivetrain voltage source inverter (VSI) 2302, an EV motor 2304, and a DC Input Port 2306. The charging port 1610 may be connected to a home/public AC charging station 1618 and/or to a DC fast charging station 2308. In some embodiments, the charging port 1610 is a CCS2 combo port as described herein. In other embodiments, the charging port 1610 is a type-2 and CHAdeMo connector as described herein.

This simultaneous AC and DC charging system uses the existing EV drivetrain (EV motor windings and inverter) by accessing a neutral point of motor winding along with the negative terminal of the DC link. This access is illustrated as DC input port 2306 ((+), O(−)) in FIG. 23. When the additional DC source 1616 is connected to the DC input port 2306, the EV motor phase windings 2304 act as filter inductors, and the drivetrain VSI 2302 is controlled as an interleaved DC-DC boost converter (IBC) to boost the external DC input voltage V_{dcE} to DC-link voltage V_{dc} The drivetrain and motor integrated interleaved DC-DC converter output is directly connected to the DC link 1604. To utilize all three legs of drivetrain VSI for fast charging, interleaved pulse width modulation (IPWM) with 120° phase-shifted carriers is used. The high value of EV motor stator winding inductance and the IPWM scheme reduces the charging current ripple to a negligible percentage, as can be seen in the simulation results discussed below. The EV motor and the drivetrain inverters are usually high power rated thus the interleaved boost converter (IBC) can be used as an interface to utilize high power DC sources. In some embodiments, the voltage range of V_{dcE} is 250V to 500V so that power from DC voltage sources ranging from solar roof tops, energy storage systems, and DC micro grids may be used. In further embodiments, power from two DC sources may be simultaneously accepted with one DC source accepted through a DC input port 2306 and the other DC source accepted from the DC pins of the charging port 1610.

Control System for Simultaneous AC and DC EV Charging Using the EV Drivetrain

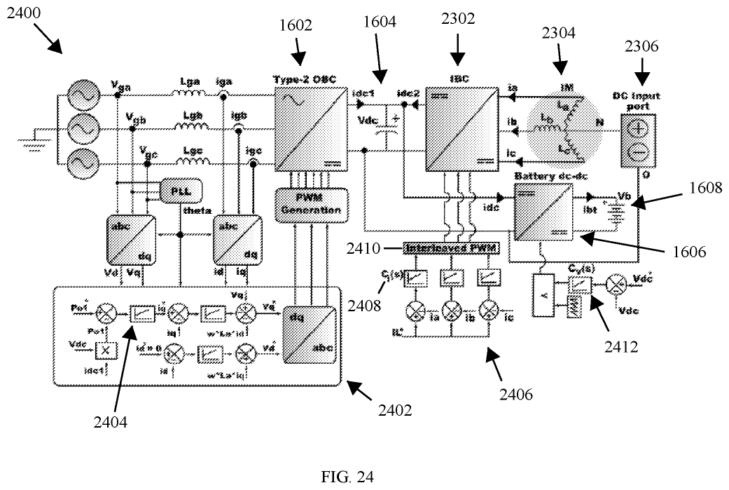

When power is fed to the DC link simultaneously from an additional DC input source and the on-board AC charger, regulation of the DC-link voltage avoids circulating current between the output of the on-board charger and the IBC. Further, the battery side DC-DC converter is controlled in voltage control mode to regulate the DC link and accept the power from the on-board charger and IBC without circulating current. In at least one embodiment, the control circuit for simultaneous AC/DC charging using the EV drivetrain provides coordinated control to balance power-sharing between AC grid and DC voltage source depending on the power rating of each input. In some embodiments, the control circuit includes type-3 three-phase on-board PFC rectifier control, control of drivetrain integrated interleaved DC-DC converter, and battery side DC-DC converter control. An exemplary control system 2400 is shown in FIG. 24. In this example, the on-board charger is a type-2 charger.

Type-2 Three Phase On-board PFC Rectifier Control

The on-board type-2 three-phase charger power rating is fixed for a given EV (max 19.4 kW). In some embodiments, the on-board type-2 charger and is controlled so that it is operated in constant power mode. Further, the unity power factor (UPF) is maintained at the grid for AC charging. FIG. 24 shows the details of the d-q control 2402 with UPF for the type-2 on-board charger 1602. To operate in constant power mode, the type-2 three-phase on-board charger is controlled with the d-q control 2402. The d axis current reference i*_{d} (reactive current) is set to zero. The output power of type-2 on-board charger Pₒ₁=(i_{dc1}*V_{dc}) is computed and is compared with the desired average output power reference P*ₒ₁ and the error is fed to a compensator 2404 to generate i*_{q} (active current reference).

Control of a Drivetrain Integrated Interleaved DC-DC Converter

The IBC is current-controlled to control each leg inductor current with respect to the current reference iL*, which is computed based on the power rating of the input DC source P_{dcE} as given as:

$$i {L}^{*} = \frac{1}{3} * \frac{{P}_{dcE}}{{V}_{dcE}} \qquad ( 45 )$$

iL* is compared with each leg phase winding current iₐ, i_{b} and i_{c} 2406 and the respective error is fed to a compensator 2408 to generate the duty ratio for switches Q₂, Q₄ and Q₆ of IBC (see FIG. 24). The current to the control transfer function for designing the current compensator is given as:

$$\frac{( s )}{( s )} = \frac{( {C}_{1} * {V}_{dc} ) s + 2 ( 1 - {D}_{1} ) {L}_{a}}{( {L}_{a} {C}_{1} ) {s}^{2} + \frac{{L}_{a}}{{R}_{2}} s + {( 1 - {D}_{1} )}^{2}} \qquad ( 46 )$$

The current compensator output gives the required boost duty ratio which is then compared with three-phase shifted carriers to generate switching pulses for the three legs of the IBC. The current compensator, for the current error compensation, is represented by:

$${c}_{i} ( s ) = 200 * \frac{50 s + 1}{s} \qquad ( 47 )$$

Interleaved PWM 2410 effectively reduces the ripple in the output current of IBC 2402. The EV motor windings 2404 act as filter inductors of the IBC in charging mode and conduct high-frequency DC currents generating no rotating magnetic field in the air gap. As discussed below in greater detail, finite element analysis (FEA) on the effect of high frequency DC currents on the three-phase induction motor shows that there is zero torque production in the air gap (see FIG. 28).

Battery Side DC-DC Converter Control

The input to the bidirectional DC-DC converter 1606 is the DC-link voltage V_{dc} with output connected to the terminals of the battery 1608. The DC-DC converter 1606 is controlled in constant voltage mode to regulate the DC link voltage. By regulating the DC-link voltage from battery side DC-DC converter 1606, the power-sharing between the Type-2 on-board charger 1602 and drivetrain integrated IBC 2302 is in accordance with their individual controller references as discussed above. The DC-link voltage V_{dc} is sensed and compared with the V_{dc}=600V (as an example V*_{dc}) and the error is fed to the compensator 2412 to generate the duty ratio to control switches of the DC/DC converter 1606. The voltage compensator 2412 transfer function is given as:

$${C}_{v} ( s ) = 80 * \frac{0.9 s + 1}{s} \qquad ( 48 )$$

Simulation

MATLAB Simulink was used to simulate simultaneous AC and DC charging using the EV drivetrain. Table 3 provides the simulation parameters.

TABLE 3
Simulation Parameters for Simultaneous AC and DC Charging
Using The EV drivetrain and a Type-2 On Board Charger

| | |
|---|---|
| Simulation Parameter | Value |

Type 2 On Board Charger

| | | |
|---|---|---|
| Input three-phase AC Voltage | 415 | V (L-L) |
| Output Power (Pₒ₁) | 19 | kW |
| Line Filter inductor (L_{ga}, L_{gb} and L_{gc}) | 2 | mH/phase |
| DC link Capacitor (C₁) | 1200 | μF |

IBC

| | | |
|---|---|---|
| DC Link Voltage (V_{dc}) | 600 | V |
| Input DC Voltage Range (V_{dcE}) | 300-500 | V |
| Motor Winding Leakage Inductance | 25 | mH/leg |
| (Lₐ, L_{b}, and L_{c}) | | |
| DC Link Capacitor (C₂) | 800 | μF |
| Motor and Drivetrain Power Rating | 100 | kW |

Battery DC-DC

| | | |
|---|---|---|
| Battery Voltage (Cutoff/Nominal/Full) | 325/450/550 | V |
| Filter Inductor (L₁) | 5 | mH |
| Input Capacitor (C₃) | 500 | μF |
| Output Capacitor (C_{b}) | 1200 | μF |

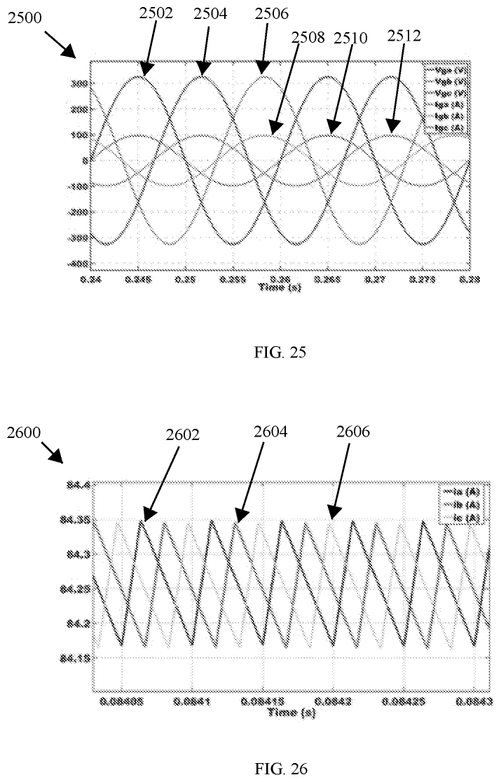

Simulation of the AC charging from a three-phase grid through a type-2 charger was conducted at 19.4 kW The input current and phase voltage of the type-2 charger (V_{ga}, V_{gb}, V_{gc} and I_{g}, I_{gb}, I_{gc}) operating at unity power factor is shown in graph 2500 of FIG. 25. In graph 2500, V_{ga} (V) is represented by line 2502, V_{gb} (V) is represented by line 2504, V_{gc} (V) is represented by line 2506, I_{ga} (A) is represented by line 2510, I_{gb} (A) is represented by line 2508, and I_{gc} (A) is represented by line 2512. Further, for the current control in each leg of IBC, a current reference, as computed in Equation (46), is used to keep power drawn from the DC voltage source connected at the DC input port within safe limits.

The high-frequency DC currents in the three legs of the IBC for 2 C rate charging with 1200° phase shift and with negligible ripple is shown in graph 2600 of FIG. 26. In graph 2600, iₐ (A) is represented by line 2602, i_{b} (A) is represented by line 2604, and i_{c} (A) is represented by line 2606. The high leakage inductance value of the motor windings and the IPWM reduces the ripple to a negligible percentage. FIG. 26 also shows that there is zero torque production in the air gap.

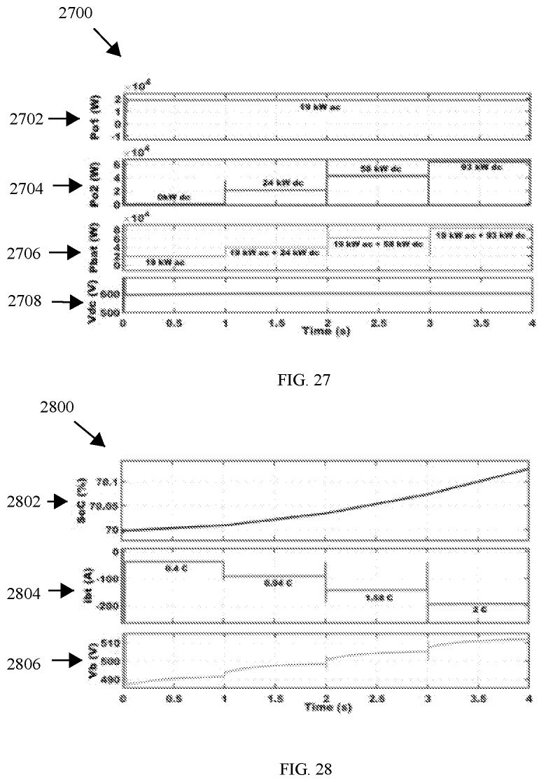

During a simulation conducted to observe the rate of charge with AC charging by itself, the type-2 on board charger was operated at a constant output power of 19 kW, and the current reference for each leg of IBC was initially kept at zero. After one second the current reference to each leg of IBC was increased in steps to charge the battery at nearly 0.5 C, 1 C, 1.5 C, and 2 C ratings (each step having a duration of 1 second). Data from this simulation of simultaneous AC and DC charging is presented in FIGS. 27-29.

FIG. 27 is a graph 2700 showing the IBC operating at different DC power levels in addition to the constant 19 kW AC power from the type-2 on-board charger with the resultant battery power and the DC link voltage regulation. Graph 2700 includes sub-graphs 2702-2706. Graph 2702 shows the average power Pₒ₁ (W) transferred through the type-2 on board charger, graph 2704 shows the average power Pₒ₂ (W) transferred through the IBC, graph 2706 shows the average power P_{bat} (W) transferred through the battery side DC-DC converter, and graph 2708 shows the DC-link voltage V_{dc} (V). As can be seen, Pₒ₁ and V_{dc} remain constant, Pₒ₂ and P_{bat} increase stepwise along with the stepwise increase in rating (0.5-2 C).

FIG. 28 is a graph 2800 showing Battery SoC (%) 2802, charging current I_{bt} (A) 2804, and terminal voltage V_{b} 2806. As can be seen, the SoC rises as the battery charge rating increases, the charging current I_{bt} decreases in a stepwise manner, and the terminal voltage V_{b} increases in a somewhat stepwise matter.

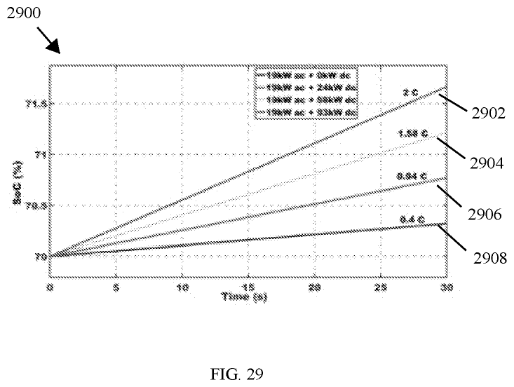

FIG. 29 is a graph 2900 showing the SoC (%) rise over 30 seconds charging time at different C ratings. Line 2902 illustrates the SoC for 19 kW AC and 93 kW DC (2 C), line 2904 illustrates the SoC for 19 kW AC and 58 kW DC (1.58 C), line 2906 illustrates the SoC for 19 kW AC and 24 kW DC (0.94 C), and line 2908 illustrates the SoC for 19 kW and 0 kW DC (0.4 C-battery charged only by the on-board battery charger). It is evident from FIG. 29 that, depending on the power rating of the external DC source, a proportional rise in the rate of charge of the EV battery is achieved with the simultaneous AC and DC charging embodiment.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A charger, comprising:
a buck converter; and
a converter that includes a totem pole BL boost structure at the input side, a switched inductor Cuk converter at the output side, the output side connected to the buck converter.

2. The charger of claim 1, wherein the totem pole BL boost structure comprises an input inductor Li, first line diode D1, second line diode D2, first switch Sw1, second switch Sw2, and an intermediate capacitor Ci, wherein:
an end of the input inductor Li is connected to an AC input vs at a first node;
a cathode of first line diode D1, first switch Sw1, and a positive side of intermediate capacitor Ci are connected at a second node;
first and second switches Sw1, Sw2 and the AC input vs are connected at a third node;
another end of the input inductor Li, an anode of first line diode D1 and a cathode of second line diode D2 are connected at a fourth node; and
an anode of second line diode D2, and second switch Sw2 are connected at a fifth node.

3. The charger of claim 2, wherein the first and second switches Sw1, Sw2 both operate simultaneously during both positive and negative half cycles, while first and second line diodes D1 and D2 operate alternately in positive and negative half-cycles.

4. The charger of claim 1 wherein the switched inductor Cuk converter comprises first and second output inductors Lo1,2 and first and second output diodes Do1,2 coupled in a switched inductor configuration.

5. The charger of claim 4, wherein
a first end of the first output inductor Lo1, an anode of first output diode Do1 and a negative side of the totem pole BL boost structure are connected at a sixth node;
a second end of the first output inductor Lo1 and an anode of second output diode Do2 are connected at a seventh node;
a cathode of first output diode Do1 and a first end of the second output inductor Lₒ₂ are connected at an eighth node;
a cathode of second output diode Do2, a second end of the second output inductor Lo2, and a negative side of the totem pole BL boost structure are connected at the fifth node.

6. The charger of claim 5, wherein the seventh node of the Cuk converter is also connected to a negative side of the DC-link and to the buck converter.

7. The charger of claim 5, wherein the eighth node of the Cuk converter is also connected to a positive side of the DC-link and to the buck converter.

8. The charger claim 1, wherein a cascaded dual loop proportional integral (PI) controller controls the buck converter.

9. The charger of claim 2, wherein the converter has a first operating mode that begins when the first and second switches Sw1, Sw2 are turned ON simultaneously and the first line diode D1 is in a conducting state.

10. The charger of claim 2, wherein the converter has a second operating mode where the first and second switches Sw1, Sw2 are OFF, and one of the first and second switches Sw1, Sw2 is forward biased.

11. The charger of claim 2, wherein the converter has a third operating mode where the first and second switches Sw1, Sw2 are OFF, and the converter is in DCM mode.

12. The charger of claim 1, wherein the converter is operated in discontinuous conduction mode (DCM).

13. The charger of claim 1, wherein a DC link voltage of the converter is controlled at 200V and delivered power is 2 kW.

14. The charger of claim 1, wherein the converter has a converter voltage gain M less than 0.5.

15. A charger, comprising:
a buck converter; and
a bridgeless (BL) Zeta converter that includes an EMI filter connected to a BL Zeta converter, which is connected to the buck converter.

16. The charger of claim 15, wherein the BL Zeta converter includes a split capacitor at an output of the BL Zeta converter.

17. The charger of claim 15, wherein the EMI filter includes a filter inductor Lf and a filter capacitor Cf, wherein a first end of the filter inductor Lf is connected to an AC input source vS and a second end of the filter inductor Lf is connected to a positive side of the filter capacitor Cf at a first node.

18. The charger of claim 15, the BL Zeta converter comprising a switch with an upper switch SU and a lower switch SL in series, an input inductor Li, a transfer capacitor Ci, a first diode D1, a second diode D2, an output inductor Lo, a first DC link capacitor Cdc1; and a second DC link capacitor Cdc2; wherein:
the switch, an end of input inductor Li and a positive side of transfer capacitor Ci are connected at a second node;
a negative side of transfer capacitor Ci, an anode of second diode D2, a cathode of first diode D1, and an end of output inductor Lo are connected at a third node;
a cathode of second diode D2, a positive side of second DC link capacitor Cdc2, and the buck converter are connected at a fourth node;
an anode of first diode D1, a negative side of first DC link capacitor Cdc1 and the buck converter are connected at a fifth node; and
a negative side of second DC link capacitor Cdc2, a positive side of DC link capacitor Cdc2, another end of output inductor Lo, another end of input inductor Li, a negative side of filter capacitor Cf, and the AC source vS are connected at a sixth node.

19. (canceled)

20. (canceled)

21. (canceled)

22. (canceled)

23. (canceled)

24. (canceled)

25. (canceled)

26. (canceled)

27. The charger of claim 1, wherein the charger is either a type-I on-board EV charger or a type-II on-board EV charger.

28. An electric vehicle configured for simultaneous AC and DC charging comprising:
an on-board charger;
a battery;
a charging port in electrical communication with the on-board charger and the battery, the charging port including a first portion configured to be in electrical communication with an AC source and a second portion configured to be in electrical communication with a DC source.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)
